(19) United States
(12) Patent Application Publication
(10) Pub. No.: US 2015/0248827 A1
(43) Pub. Date: Sep. 3, 2015

(54) METHOD AND APPARATUS FOR DETECTING AIR DUCT

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: MING YU, Shenzhen (CN)

(21) Appl. No.: 14/524,835

(22) Filed: Oct. 27, 2014

(30) Foreign Application Priority Data
Feb. 28, 2014 (CN) 2014100698598

(51) Int. Cl. G08B 21/18

(52) U.S. Cl. CPC G08B 21/18

(57) ABSTRACT

Apparatus for detecting whether an air duct is installed properly includes a first sensor, a second sensor, a basic management controller, and an alarm unit. The first sensor and the second sensor detect whether the air duct is installed properly, and outputs a high voltage level installing signal respectively when the air duct is not installed properly. The basic management controller receives the high voltage level installing signals, and outputs an alarm signal. The alarm unit receives the alarm signal, and alarms to prevent a server system turning on. The first sensor and the second sensor output a low voltage level installing signal respectively when the air duct is installed properly. The basic management controller receives the low voltage level installing signals, and outputs a turning on signal to turn on the server system.

### CROSS-REFERENCE TO RELATED APPLICATIONS

This application claims priority to Chinese Patent Application No. 201410069859.8 filed on Feb. 28, 2014, the contents of which are incorporated by reference herein.

### FIELD

The subject matter herein generally relates to a method and apparatus for detecting air duct.

### BACKGROUND

Air duct is widely used for facilitating heat dissipation of electronic components of a computer system. The air duct covers on the electronic components of the computer system to guide airflow from fans to the electronic components.

### BRIEF DESCRIPTION OF THE DRAWINGS

Implementations of the present disclosure will now be described, by way of example only, with reference to the attached figures.

FIG. 1 is a block diagram of an embodiment of an apparatus for detecting air duct.

FIG. 2 is a flowchart of an embodiment of a method for detecting air duct.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The present disclosure is described in relation to an for detecting whether an air duct is installed properly includes a first sensor, a second sensor, a basic management controller, and an alarm unit. The first sensor and the second sensor detect whether the air duct is installed properly, and outputs a high voltage level installing signal respectively when the air duct is not installed properly. The basic management controller receives the high voltage level installing signals, and outputs an alarm signal. The alarm unit receives the alarm signal, and alarms to prevent a server system turning on. The first sensor and the second sensor output a low voltage level installing signal respectively when the air duct is installed properly. The basic management controller receives the low voltage level installing signals, and outputs a turning on signal to turn on the server system.

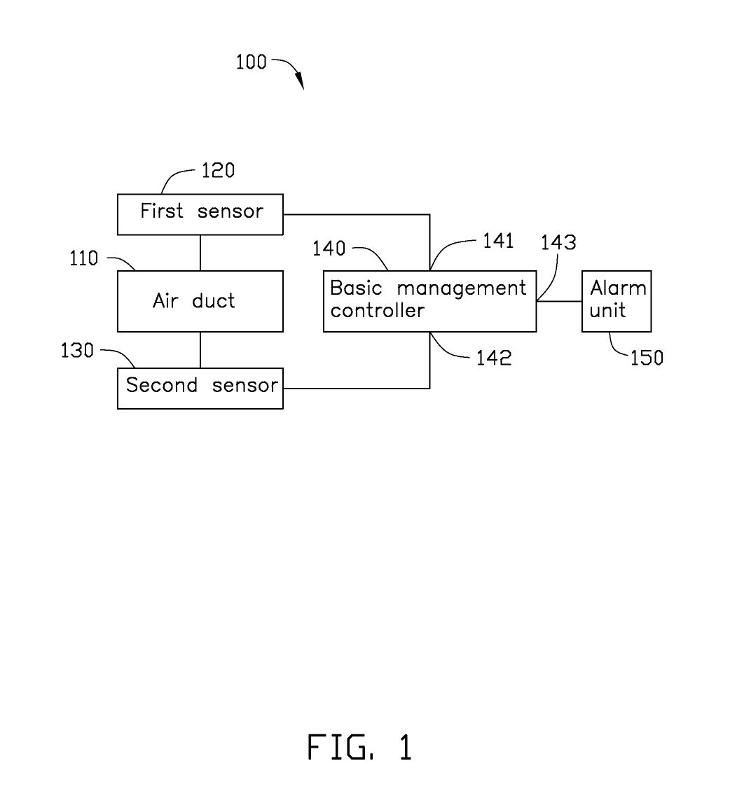

FIG. 1 illustrates an embodiment of an apparatus for detecting whether an air duct 110 is installed properly in a server system 100. The detecting apparatus includes a first sensor 120, a second sensor 130, a basic management controller 140, and an alarm unit 150.

The basic management controller 140 includes a first detecting signal input terminal 141, a second detecting signal input terminal 142, and an alarm signal output terminal 143. The first detecting signal input terminal 141 and the second detecting signal input terminal 142 are electrically coupled to the first sensor 120 and the second sensor 130 respectively. The alarm signal output terminal 143 is electrically coupled to the alarm unit 150.

In one embodiment, the first sensor 120 and the second sensor 130 are contacting type sensors. The first sensor 120 and the second sensor 130 are located on two sides of the air duct 110. When the air duct 110 is installed properly, the first sensor 120 and the second sensor 130 are pressed by the air duct 110 and determine the air duct 110 is installed properly. The alarm unit 150 is a light emitting unit or a sound producing unit. The alarm unit 150 emits light or produces a sound when the air duct 110 is not installed properly.

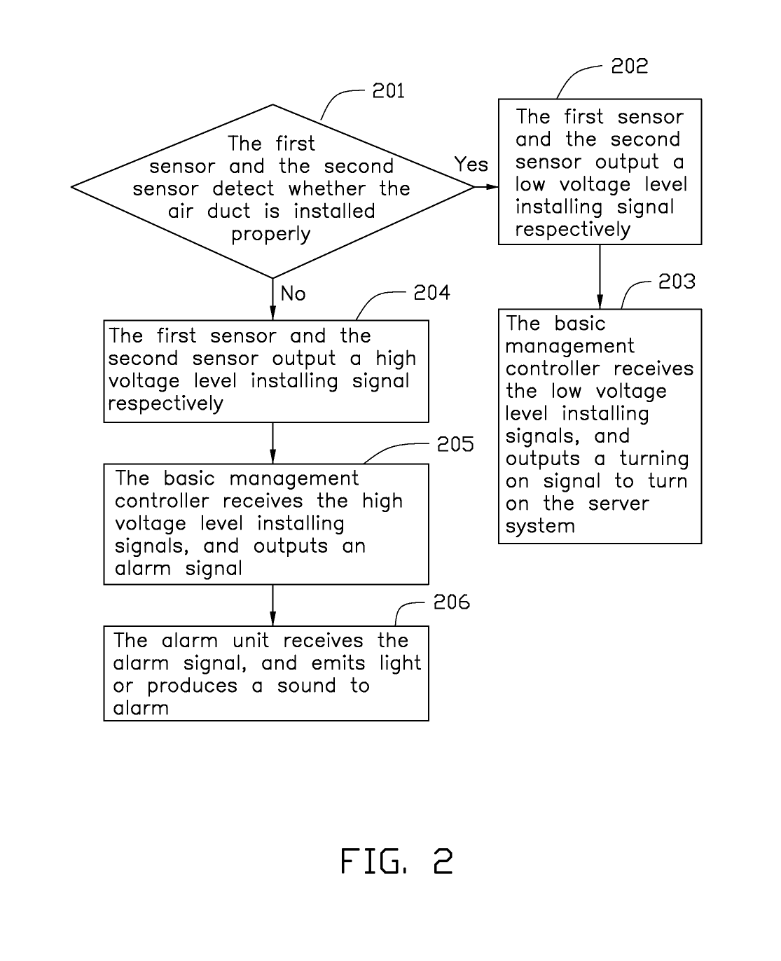

FIG. 2 illustrates flowchart of an embodiment of a method for detecting whether the air duct 110 is installed properly. Depending on the embodiment, certain steps described below may be removed, while others may be added, and the sequence of the steps may be altered. In at least one embodiment, the method for detecting the air duct 110 utilizing the above-described system includes the following steps.

In 201, the first sensor 120 and the second sensor 130 detect whether the air duct 110 is installed properly; if the air duct 110 is installed properly, the process goes to step 202; if the air duct 110 is not installed properly, the process goes to step 204.

In 202, the first sensor 120 and the second sensor 130 output a low voltage level installing signal respectively.

In 203, the basic management controller 140 receives the low voltage level installing signals, and outputs a turning on signal to turn on the server system 100.

In 204, the first sensor 120 and the second sensor 130 output a high voltage level installing signal respectively.

In 205, the basic management controller 140 receives the high voltage level installing signals, and outputs an alarm signal.

In 206, the alarm unit 150 receives the alarm signal, and emits light or produces the sound to alarm.

In one embodiment, the basic management controller 140 outputs the turning on signal when both of the first sensor 120 and the second sensor 130 output low voltage level installing signals. When one of the two sides of the air duct 110 is installed properly, one of the first sensor 120 and the second sensor 130 outputs the high voltage level installing signal. The basic management controller 140 outputs the alarm signal when receives the high voltage level installing signal. The alarm unit 150 receives the alarm signal, and emits light or produces the sound to prevent the server system 100 turning on.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An apparatus for detecting whether an air duct is installed properly, comprising:
a first sensor and a second sensor configured to detect whether the air duct is installed properly, and output a high voltage level installing signal respectively when the air duct is not installed properly;
a basic management controller configured to receive the high voltage level installing signals, and output an alarm signal; and
an alarm unit configured to receive the alarm signal, and alarm to prevent a server system turning on;
wherein the first sensor and the second sensor are configured to output a low voltage level installing signal respectively when the air duct is installed properly; and the basic management controller is configured to receive the low voltage level installing signals, and output a turning on signal to turn on the server system.

2. The apparatus of claim 1, wherein the basic management controller comprises a first detecting signal input terminal, a second detecting signal input terminal, and an alarm signal output terminal; the first detecting signal input terminal and the second detecting signal input terminal are electrically coupled to the first sensor and the second sensor respectively; and the alarm signal output terminal is electrically coupled to the alarm unit.

3. The apparatus of claim 2, wherein the first sensor and the second sensor are contacting type sensors; and the first sensor and the second sensor are located on two sides of the air duct.

4. The apparatus of claim 3, wherein when the air duct is installed properly, the first sensor and the second sensor are pressed by the air duct and determine the air duct is installed properly.

5. The apparatus of claim 4, wherein the alarm unit is a light emitting unit or a sound producing unit; and the alarm unit is a light emitting unit or a sound producing unit; and the alarm unit is configured to emit light or produce a sound to alarm when receives the alarm signal.

6. A method for detecting whether an air duct is installed properly, comprising:
detecting whether the air duct is installed properly by a first sensor and a second sensor;
outputting a low voltage level installing signal by the first sensor and the second sensor respectively when the air duct is installed properly;
receiving the low voltage level installing signals, and outputting a turning on signal to turn on a server system by a basic management controller;
outputting a high voltage level installing signal by the first sensor and the second sensor respectively when the air duct is not installed properly;
receiving the high voltage level installing signals, and outputting an alarm signal by the basic management controller; and
receiving the alarm signal, and emitting light or producing a sound to alarm by an alarm unit.

7. The method of claim 6, wherein the basic management controller is configured to output the turning on signal when both of the first sensor and the second sensor output low voltage level installing signals.

8. The method of claim 7, wherein when one of the two sides of the air duct is installed properly, one of the first sensor and the second sensor is configured to output the high voltage level installing signal, the basic management controller is configured to output the alarm signal when receives the high voltage level installing signal, and the alarm unit is configured to receive the alarm signal, and emit or produce the sound to prevent the server system turning on.

9. Air duct position confirmation system comprising:
a first sensor;
a second sensor;
a management controller; and
an alarm unit;
wherein, the first sensor and the second sensor output a low voltage level installing signal when the air duct is properly positioned, and output a high voltage level installing signal when the air improperly positioned;
wherein, the management controller receives the first sensor output and the second sensor output; and
wherein, the management controller activates the alarm unit when the management controller receives a high voltage level installing signal from at least one of the first sensor and the second sensor.
